(19) United States
(12) Patent Application Publication
(10) Pub. No.: US 2023/0161378 A1
(43) Pub. Date: May 25, 2023

(54) DISPLAY ASSEMBLY FOR TERMINAL DEVICE, TERMINAL DEVICE AND METHOD FOR OPERATING DISPLAY ASSEMBLY

(71) Applicant: GUANGDONG OPPO MOBILE TELECOMMUNICATIONS CORP., LTD., Dongguan (CN)

(72) Inventors: Jintong Zhu, Dongguan (CN); Yihan Fu, Dongguan (CN)

(21) Appl. No.: 17/991,641

(22) Filed: Nov. 21, 2022

Related U.S. Application Data
(63) Continuation of application No. PCT/CN2020/096382, filed on Jun. 16, 2020.

(51) Int. Cl. G06F 1/16; G06F 3/0488; G09G 5/00

(52) U.S. Cl. CPC G06F 1/1637; G06F 3/0488; G09G 5/003; G09G 2310/0237

(57) ABSTRACT

A display assembly for a terminal device, a terminal device, and a method for operating a display assembly are provided. The display assembly for a terminal device includes a display layer, capable of displaying information and being turned on and off; and a switchable film, disposed above the display layer, and capable of changing opacity of the switchable film.

### CROSS-REFERENCE TO RELATED APPLICATIONS

This application is a continuation of International Application No. PCT/CN2020/096382 entitled “DISPLAY ASSEMBLY FOR TERMINAL DEVICE, TERMINAL DEVICE AND METHOD FOR OPERATING DISPLAY ASSEMBLY” filed on Jun. 16, 2020, the entire content of which is incorporated herein by reference.

### TECHNICAL FIELD

The present disclosure relates to the field of terminal devices, and particularly, to a display assembly for a terminal device, a terminal device, and a method for operating a display assembly.

### BACKGROUND

With the popularization of mobile terminal equipment, more and more functions of terminal equipment and various modes of terminal equipment have been developed. In order to better satisfy the users, there is a need to develop more modes of terminal equipment to better provide services for users.

### SUMMARY

The present disclosure provides a display assembly for a terminal device, a terminal device, and a method for operating a display assembly.

According to a first aspect of the present disclosure, there is provided a display assembly for a terminal device, including: a display layer, capable of displaying information and being turned on and off; and a switchable film, disposed above the display layer, and capable of changing opacity of the switchable film.

According to a second aspect of the present disclosure, there is provided a terminal device which includes the display assembly according to the first aspect.

According to a third aspect of the present disclosure, there is provided a method for operating a display assembly of a terminal device, the display assembly comprising: a display layer capable of displaying information and being turned on and off; and a switchable film disposed above the display layer, and capable of changing opacity of the switchable film; a first controller for controlling the switchable film; and a second controller for controlling the display layer, the method comprising an operation of: controlling by the first controller, the opacity of the switchable film according to inputs to the terminal device and controlling, by the second controller, the display layer to be turned on and off and display information according to inputs to the terminal device, so as to make the terminal device to be in a particular status.

It is to be understood that the above general descriptions and detailed descriptions below are only exemplary and explanatory and not intended to limit the present disclosure.

### BRIEF DESCRIPTION OF DRAWINGS

The accompanying drawings, which are incorporated in and constitute a part of this specification, illustrate embodiments consistent with the present disclosure and, together with the specification, serve to explain the principles of the present disclosure.

FIG. 1 illustrates a display assembly for a terminal device according to at least some embodiments of the present disclosure.

FIG. 2 illustrates a display assembly for a terminal device according to at least some embodiments of the present disclosure.

FIG. 3 illustrates a control system which may be included in the display assembly according to at least some embodiments of the present disclosure.

FIG. 4A, FIG. 4B and FIG. 4C illustrate different statuses of the display assembly according respectively according to at least some embodiments.

FIG. 5A, FIG. 5B, FIG. 5C and FIG. 5D illustrate different statuses of the display assembly according respectively according to at least some embodiments of the present disclosure.

FIG. 6 illustrates a flow chart of a method for operating a display assembly of a terminal device according to at least some embodiments of the present disclosure.

FIG. 7 illustrates a flowchart of the basic operation of the lock/unlock mechanism in relation to dimming of the LC layer and activation of the display layer according to at least some embodiments of the present disclosure.

FIGS. 8A-8E and FIGS. 9A-9E illustrate some of half-lock transitional statuses according to at least some embodiments of the present disclosure.

FIG. 10 illustrates an expanded version of the system flowchart described by FIG. 7 according to at least some embodiments of the present disclosure.

### DETAILED DESCRIPTION

Exemplary implementations will now be described more comprehensively with reference to the accompanying drawings. However, the exemplary implementations may be implemented in various forms, but should not be understood to be limited to examples elaborated herein; and instead, providing these implementations enables the present disclosure to convey the concept of the exemplary implementations to those skilled in the art more comprehensively and completely. The accompanying drawings only schematic diagrammatize the present disclosure, and may not be drawn to scale. The same accompanying drawing reference signs in the drawings represent the same or similar parts, so that repeated descriptions about them are eliminated.

In addition, the described characteristics, structures or features may be combined to one or more implementations in any proper manner In descriptions made below, many specific details are provided for completely understanding the implementations of the present disclosure. However, those skilled in the art realize that the technical solutions of the present disclosure may be practiced with one or more of the specified details eliminated, or another method, component, device, operation and the like may be adopted. Under other conditions, a known structure, method, device, implementation, material or operation is not shown or described in detail so as to avoid distraction and obscuring of each aspect of the present disclosure.

Some block diagrams shown in the accompanying drawings are functional entities, and are not required to physically or logically correspond to independent entities. These functional entities may be implemented in a software form, or these functional entities may be implemented in one or more hardware modules or integrated circuits, or these functional entities may be implemented in different networks and/or processor devices and/or microcontroller devices.

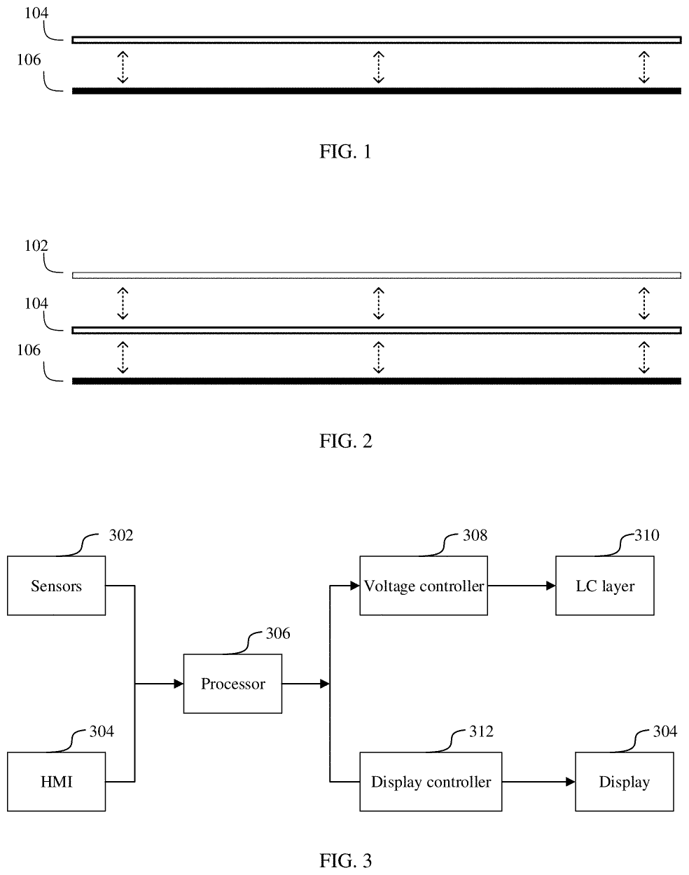

FIG. 1 illustrates a display assembly for a terminal device according to at least some embodiments of the present disclosure.

As illustrated in FIG. 1, the display assembly may include a display layer 106 and switchable film 104.

The display layer 106 is capable of displaying information and being turned on and off. The switchable film 104 is disposed above the display layer, and is capable of changing opacity of the switchable film.

According to at least some embodiments of the present disclosure, the switchable film 104 may be a layer of switchable smart film which is switchable between a scattering mode and a clear mode in an analogue way. This film is available on the market from a number of companies including Toppan.

Layering this film on top of an OLED or LCD display has not been done in the related art.

In a related art, static optical films are layered on top of traditional displays, for example, a one-way mirror film is layered on top of a film that allows some TVs to appear like a mirror when the display is off.

According to some embodiment of the present disclosure, the capability of the system may be actively controlled, so that the status of dimming of the opaque and switchable or reflective layer can be adapted to different scenarios of user experience. While the solution employed by mirror TVs is passive, resulting in optical properties intrinsic within the mirror overlay that hides or display the underlying image based on the amount of light used, in our case the filtering overlay ability to scatter the light and to conceal the underlying image can be directly controlled independently from how much light is emitted by the display.

According to some embodiments, the display assembly may further include a cover, for example transparent cover 102, as illustrated in FIG. 2. However, it is to be understood that the transparent cover 102 is not necessarily included in the display assembly depending on design of the terminal device and develop of the techniques for the terminal device.

The display layer 106 may be, for example, an Organic Light Emitting Display (OLED), or Liquid Crystal Display (LCD) or Micro Light Emitting Display (LED) display unit, capable of emitting light, be turned on and off and dimmed The LC Layer 104 may be composed of a liquid crystal material or encapsulated liquid crystal material which is capable of changing its light scattering properties when current is passed through it. The cover 102 may be a glass panel that may be integrating a touch sensitive layer (which may be ideal for smartphone applications) or that may not be integrating a touch sensitive layer.

The LC layer 104 may implemented with liquid crystals, but it is to be understood that it may be also composed of other types of smart materials exhibiting optical properties, such as electrochromic glass.

FIG. 3 illustrates a control system which may be included in the display assembly according to at least some embodiments of the present disclosure.

As illustrated in FIG. 3, the display assembly may further include a first controller, which is illustrated as a voltage controller 308, and a second controller, which is illustrated as a display controller 312.

The first controller 308 may be configured to control the opacity of the switchable film (which is shown as LC layer 310 in FIG. 3) according to inputs to the terminal device and the second controller 312 may be configured to control the display layer 304 to be turned on and off and display information according to the inputs to the terminal device, so as to make the terminal device to be in a particular status.

The display assembly may further include at least one sensor 302 and/or at least one Human-Machine Interface (HMI) 304. The display assembly may further include at least one processor 306.

The at least one sensor 302 may be configured to sense change in condition of the terminal device and send a sensing result to at least one processor 306 as inputs, and at least one HMI 304 may be configured to receive instructions and send the instructions to the at least one processor 306 as inputs.

The at least one processor 306 may be configured to receive the inputs to the terminal device from the at least one sensor 302 and/or at least one HMI 304 and send the inputs to the first controller 308 and second controller 312.

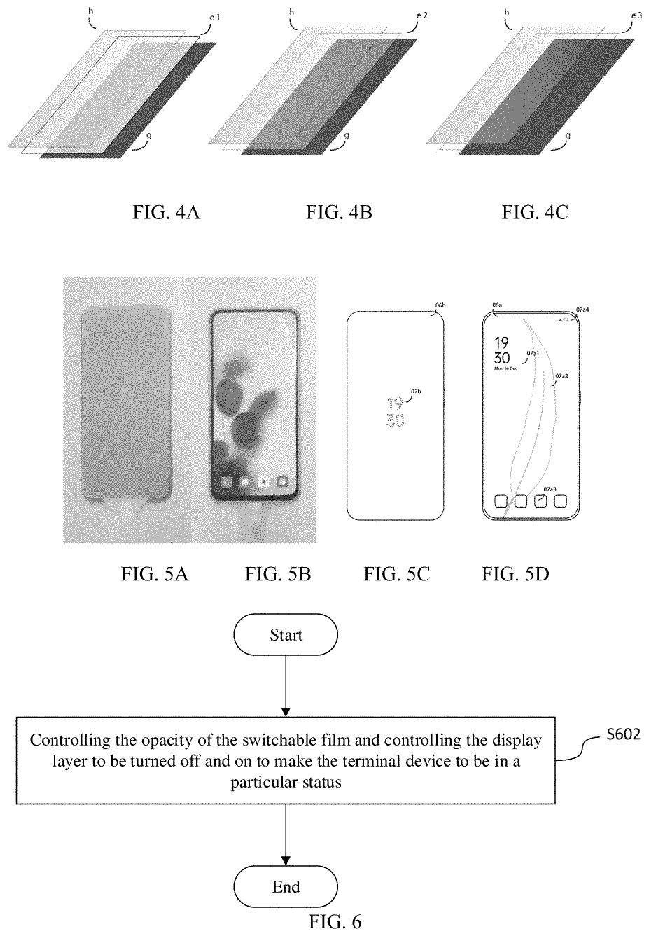

According to some embodiments, the processor 306 (e.g., central processor) receives inputs (such as ambient light, orientation, motion, proximity or other) from sensors 302 and HMI 304 (Human-Machine Interface elements such as touchscreen, buttons, and other input sensors dedicated to interaction, including accessory devices connected to the main device for example via Bluetooth, Wi-Fi or other standards). The processor 306 may send control messages to a voltage controller 308 that modulates current passing through the LC Layer 310 and a display controller 302 that controls on/off and dimming status of the display layer 304. The status of the LC layer 310 can be any between the values displayed in FIG. 4, such as 100% opacity (e1) 50% opacity (e2) and 0% opacity (e3).

According to at least some embodiments, the first controller 308 may be configured to control the opacity of the switchable film to 100% and the second controller 312 may be configured to control the display layer to display a lockscreen Graphical User Interface (GUI) to make the terminal device to be in a locked status.

According to at least some embodiments, the first controller 308 may be configured to control the opacity of the switchable film to 0% and the second controller is configured to control the display layer to light up to make the terminal device to be in an unlocked status.

According to at least some embodiments, the first controller 308 may be configured to control the opacity of the switchable film to 60% to 90% and the second controller is configured to control the display layer to display an interface of at least one particular application, to make the terminal device to be in a half-locked status where the at least one particular application is capable of being accessed.

According to at least some embodiments, the first controller 308 may be configured to control the opacity of the switchable film to 100% and the second controller is configured to control the display layer to use Always On Display (AOD) functionality to display a graphical representation of notifications from at least one application having priority, to make the terminal device to be in a locked status.

According to at least some embodiments, the first controller 308 may be configured to control the opacity of the switchable film to 10% to 30%, and the second controller is configured to control the display layer to display information in a summarized way, to make the terminal device to be in a half-locked status.

According to at least some embodiments, the switchable film is made of at least one of liquid crystal or electrochromic glass.

According to at least some embodiments, the opacity of the switchable film is ranged from 0% to 100%.

FIG. 4A, FIG. 4B and FIG. 4C illustrate different statuses of the display assembly according respectively according to at least some embodiments.

According to at least some embodiments, the display assembly may include a glass cover h, a LC layer e, and a display layer g.

In FIG. 4A, the LC layer el is of 100% opaque. In FIG. 4B, the LC layer e2 is of 50% opaque. In FIG. 4C, the LC layer e3 is of 0% opaque.

An implementation of this system is displayed in FIG. 4A, FIG. 4B and FIG. 4C, including both photographic evidence and an illustration of the system in 100% opacity (FIG. 4A, e1) and 0% opacity (FIG. 4C, e3).

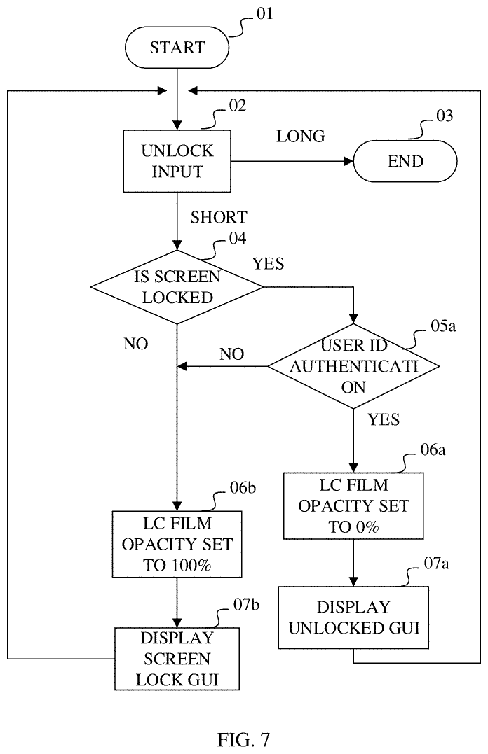

In FIG. 4B and FIG. 5B, the system illustrated represents a locked screen status with LC layer in 100% opacity (FIG. 4A, e1/FIG. 5D and FIG. 7 block 06b) and display module 304 displaying lockscreen GUI. This status may or may not be displaying depending on user settings elements related to AOD (Always On Display) functionality, such as light up clock (FIG. 5D and FIG. 7, block 07b).

In FIG. 5B and 5D, the system illustrated represents an unlocked status with LC layer in 0% opacity (FIG. 4C, e3/FIG. 5D and FIG. 7, block 06a) and lit up display module (FIG. 5B and FIG. 7, block 07a) that may display a homescreen GUI (as landing page after standard unlock procedure) that may be comprised of elements such as battery/signal indicators (FIG. 5D), clock/date (FIG. 5D), Background image (FIG. 5D), application icons/dock (FIG. 5D).

According to at least some embodiments, the switchable film 104 may be a switchable light diffusing layer is laminated above a smartphone display.

Laminating a switchable light diffusing layer above a smartphone display provides a number of advantages as follows.

When the display layer is off, the switchable light diffusing layer can be in ‘scattering’ mode and therefore scatter the light incident onto the front surface of the display. This makes the display layer appears white instead of black when off. The primary advantage of this is aesthetic, for instance the screen could become ‘invisible’ when off. There are secondary behavioral advantages, for instance the user might pick up their phone without the behavioral que of a black screen being visible.

When the display layer is on, the switchable light diffusing layer can be in ‘scattering’ mode and therefore scatter the light passing through the layer from the display. The advantage of this is aesthetic, for instance the shapes and colors on the display layer could form attractive, soft pastel colored shapes with depth and without specular artifacts (reflections). These visual effects difficult to achieve with only a display.

When the display layer is on, the switchable light diffusing layer can be in any number of ‘semi-scattering’ modes and therefore scatter the light incident onto the front surface of the display layer and the light passing through the layer from the display layer somewhat. The primary advantage of this is aesthetic, a number of different visual effects can be created that are difficult to achieve with only a display. For instance, an attractive notification screen could be shown that shows only very limited details, the secondary advantage of this is behavioral, for instance, having only limited details viewable may prevent a user becoming distracted.

These advantages are provided in such a way that normal display operation can remain unaffected when it is desirable to do so. It is also possible that when the display layer is on, the switchable light diffusing layer can be in ‘clear’ mode and so have minimal effect on normal display operation, retaining clarity, resolution, sharpness, brightness, color balance and other typical display metrics.

According to at least some embodiments, there is provided a terminal device. The terminal includes the display assembly as described in conjunction with FIG. 1, FIG. 2 and/or FIG. 3. In other words, the above description about the display assembly may be also applied to the terminal device.

FIG. 6 illustrates a flow chart of a method for operating a display assembly of a terminal device according to at least some embodiments of the present disclosure.

The display assembly includes a display layer capable of displaying information and being turned on and off; and a switchable film disposed above the display layer, and capable of changing opacity of the switchable film; a first controller for controlling the switchable film; and a second controller for controlling the display layer.

As illustrated in FIG. 6, the first controller controls the opacity of the switchable film according to inputs to the terminal device and the second controller controls the display layer to be turned on and off and display information according to inputs to the terminal device, so as to make the terminal device to be in a particular status.

According to at least some embodiments, the terminal device may further include at least one processor, and may further include at least one sensor and/or at least one Human-Machine Interface (HMI). The method may further include: sensing, by the least one sensor, change in condition of the terminal device and sending a sensing result to at least one processor as inputs, and/or receiving, by at least one HMI, instructions from a user of the terminal device and sending the instructions to the at least one processor as inputs; and receiving, by the at least one processor, the inputs to the terminal device from the at least one of the sensor or HMI, and sending the inputs to the first controller and second controller.

According to at least some embodiments, the operation may include: controlling, by the first controller, the opacity of the switchable film to 100% and controlling, by the second controller, the display layer to display a lockscreen Graphical User Interface (GUI) to make the terminal device to be in a locked status.

According to at least some embodiments, the operation may include: controlling, by the first controller, the opacity of the switchable film to 0%, and controlling, by the second controller, the display layer to light up, to make the terminal device to be in an unlocked status.

According to at least some embodiments, the operation may include: controlling, by the first controller, the opacity of the switchable film to 60% to 90% and controlling, by the second controller, the display layer to display an interface of at least one particular application, to make the terminal device to be in a half-locked status where the at least one particular application is capable of being accessed.

According to at least some embodiments, the operation may include: controlling, by the first controller, the opacity of the switchable film to 100% and controlling, by the second controller, the display layer to use Always On Display (AOD) functionality to display a graphical representation of notifications from at least one application having priority, to make the terminal device to be in a locked status.

According to at least some embodiments, the operation may include: controlling, by the first controller, the opacity of the switchable film to 10% to 30% and controlling, by the second controller, the display layer to display information in a summarized way, to make the terminal device to be in a half-locked status.

FIG. 7 illustrates a flowchart of the basic operation of the lock/unlock mechanism in relation to dimming of the LC layer and activation of the display layer.

According to at least some embodiments, the operation may include: when the display assembly is in an unlocked status (FIG. 7, block 04), responsive to receiving an input for changing status of the display assembly (FIG. 7, block 02), controlling, by the first controller, the opacity of the switchable film to 100% and controlling, by the second controller, the display layer to display a lockscreen Graphical User Interface (GUI) to make the terminal device to be in a locked status (FIG. 7, block 06b).

According to at least some embodiments, the operation may include: when the display assembly is in a locked status (FIG. 7, block 04), responsive to receiving an input for changing status of the display assembly (FIG. 7, block 02), performing, by the at least one processor, user identification authentication (FIG. 7, block 05a); and responsive to a positive result of the user identification authentication, controlling, by the first controller, the opacity of the switchable film to 0% and controlling, by the second controller, the display layer to light up, to make the terminal device to be in an unlocked status (FIG. 7, block 06a).

Specifically, at start of the operation (FIG. 7, block 01), the system listens for lock/unlock input (FIG. 7, block 02), that can be processed via the operation of a lock/unlock physical key on the device or analogue HMI interface such as pressure sensitive areas in the device display or side frame.

When input is detected, a timer for the time of the input being pressed is activated.

Based on a defined time threshold a long press of the lock/unlock key will activate a prompt to turn the device off, bringing the system to end status (FIG. 7, block 03).

Based on a defined time threshold, a short press of the lock/unlock key will move the system to the next status block that verifies the status of the display (FIG. 7, block 04) (locked or unlocked).

If the display is not locked (answer NO) the short press will move the system to locked status (FIG. 5A/FIG. 5C) by setting the LC layer opacity to 100% (FIG. 7, block 06b), displaying the screen lock GUI (FIG. 7, block 07b) and moving back to the unlock input listener status (FIG. 7, block 02).

If the status of the system is instead locked during the verification of lock/unlock status (FIG. 7, block 04) the system moves to the block where it verifies the user ID authentication (FIG. 7, block 05a). This authentication can use various methods according to user preferences set up in the settings panel, such as fingerprint authentication, face recognition, voice identity recognition, password/unlock code input or recognition of connected devices such as smartwatch being present.

If the user Identity verification (FIG. 7, block 05a) is not successful (answer NO) the system reverts to locked status after setting opacity of the LC layer to 100% (FIG. 7, block 06b) and displaying screen lock GUI (FIG. 7, block 07b).

Depending on the user defined identification method the user identity authentication can transitorily modify the opacity of the LC layer so that, for example, it matches a threshold of opacity that allows the front camera and other optical sensor to recognize the user face.

If the user authentication (FIG. 7, block 05a) is successful (answer YES) the status of the system moves toward unlocked status (FIG. 5B/FIG. 5D) a different block by setting the LC layer opacity to 0% (FIG. 7, block 06a) and displaying the unlocked GUI (FIG. 7, block 07a) on the display module.

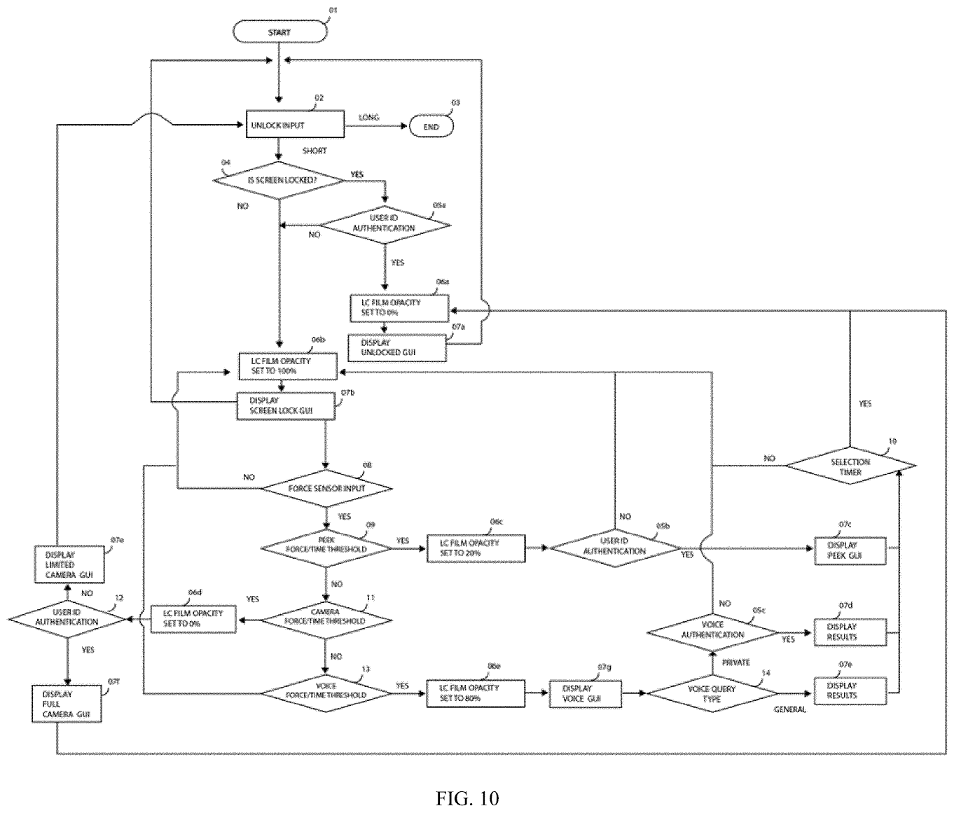

According to at least some embodiments, the operation may include: responsive to receiving an input for activating at least one particular application (FIG. 10, block 13), controlling, by the first controller, the opacity of the switchable film to 60% to 90% and controlling, by the second controller, the display layer to display an interface of the at least one particular application, to make the terminal device to be in a half-locked status where the at least one particular application is capable of being accessed (FIG. 10, block 06e).

According to at least some embodiments, the operation may include: when the display assembly is in an unlocked status (FIG. 10, block 04), responsive to receiving an input for changing status of the display assembly (FIG. 10, block 02), controlling (FIG. 10, block 06b), by the first controller, the opacity of the switchable film to 100% and controlling (FIG. 10, block 07b), by the second controller, the display layer to use Always On Display (AOD) functionality to display a graphical representation of notifications from at least one application having priority, to make the terminal device to be in a locked status.

According to at least some embodiments, the operation may include: responsive to receiving an input for changing status of the display assembly (FIG. 10, block 09) to a half-locked status, controlling, by the first controller, the opacity of the switchable film to 10% to 30% (FIG. 10, block 06c); performing, by the at least one processor, user identification authentication (FIG. 10, block 05b); and responsive to a positive result of the user identification authentication (FIG. 10, block 05b, yes), controlling, by the second controller, the display layer to display information in a summarized way, to make the terminal device to be in a half-locked status (FIG. 10, block 07c).

According to at least some embodiments, the switchable film is made of at least one of liquid crystal or electrochromic glass.

According to at least some embodiments, the opacity of the switchable film is ranged from 0% to 100%.

### Principles of Operation (Advanced)

If during the locked state the force sensor (FIG. 10, block 08) does not recognize either zero input or the threshold force input for Peek (FIG. 10, block 09, answer NO), or the threshold for camera shortcut (FIG. 10, block 11, answer NO), it will attempt to recognize the voice input force threshold (FIG. 10, block 13). If this threshold is not recognized (FIG. 10, block 13, answer NO) the system remain in locked status with LC layer at 100% opacity (FIG. 10, block 06b) and display with screen lock GUI (FIG. 10, block 07b), if otherwise the force sensor (FIG. 10, block 08) recognizes the threshold for voice input (defined for example as a strong squeeze at more than 70% total possible force reading, for a duration superior to 1.5 seconds) it will proceed to start voice input mode by setting LC layer opacity at 80% (06e) and display voice GUI (FIG. 10, block 07g). During this status the system will translate the speech into text (STT) and analyze the type of query performed (FIG. 10, block 14).

The system previously described in its basic functionality is also able to display additional states due to its capability to separately control the LC layer and the display layer. This section describes this more advanced operation methods for key scenarios.

This more advanced operation does not require any modification or different setup in the core system diagram, therefore all elements described in the previous paragraphs and FIGS. 1-7 remain valid.

By taking advantage of the capability of the LC layer to be dimmed to different levels and the association of the 100% opacity status with the locked state and of the 0% opacity status with the unlocked state, new states that are situated between locked and unlocked are possible by controlling the opacity of the LC layer in coordination with the brightness of the display layer.

Definition of the problem and description of intended use of the in-between (half lock) statuses will be described below.

Smartphone addiction is a growing concern in the design of the user experience of mobile devices. As the use of smartphone becomes integral part of the users daily life, there is an increased concern about how continue notifications and inflow of data from social networks is driving the users to spend excessive time looking at their smartphone displays and consuming digital content.

One of the key issues regarding this comes from the need to check notifications and important apps by unlocking the display. Once the user has unlocked the display to check something important, new notifications and other distractions such as games and media result in more time than needed being spent using the device and looking at its screen?.

In order to fight these addiction mechanics we propose to use the LC layer as a physical filter to enable a progressive access to the device, giving to the user freedom and control about how much of the phone functionalities they want to access and by allowing access to only strictly essential information and assistive functionalities in a status of the device that is different from the one of the smartphone fully unlocked.

Those statuses, while effectively accessing some of the functions and data that would be available with unlocked phone, are transitional and intended to either revert to locked status or be progressed to fully unlocked by the user via further selection.

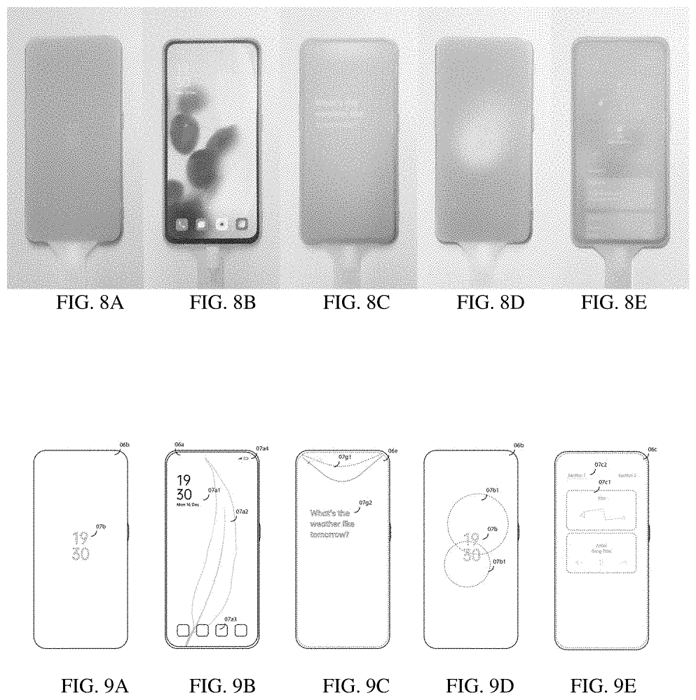

FIGS. 8A-8E and FIGS. 9A-9E detail some of these half-lock transitional statuses, while FIG. 10 shows a full flowchart diagram of how these statuses are activated and their behaviors.

FIG. 8A/FIG. 9A and FIG. 8B/FIG. 9B show the phone fully locked and fully unlocked respectively, and are analogue to FIG. 4A/FIG. 5A and FIG. 4B/FIG. 5B.

FIG. 8C/FIG. 9C illustrates a type of half-lock status where the user can access voice assistant, in this status the LC layer opacity is changed to 80% (FIG. 10, block 06e) and the display layer displays a voice input GUI (FIG. 10, block 07g) that may comprised of various elements such as a voice tracking/feedback indicator (FIG. 9C) that animates following a voice intensity and waveform and textual transcript of the STT (speech to text) input (FIG. 9C).

FIGS. 8D, 9D and 8E, 9E illustrate a use of the combination of LC layer and display aimed at allowing filtering of notifications, these statutes work in conjunction and are defined as Canvas status (FIGS. 8D, 9D) and Peek status (FIGS. 8E, 9E).

Canvas status (FIGS. 8D, 9D) is an evolution of the locked status (FIG. 10, block 07b), where the LC layer (FIG. 10, block 06b) is still at 100% opacity, while the display layer uses the AOD (Always On Display) functionality to display a graphical representation of notifications from applications that the user has set as priority, this screen still includes elements of the normal locked status such as a clock (FIG. 9D, 07b) as well as colorful bubbles (FIG. 9, 07b1) that represent the number and type of notifications. Each bubble has a unique user set color associated to a specific application that the user has set as prioritary, the size of the bubble depends on the number of unread notifications from the application. This system allows the user to be aware of important information by surfacing it without having to worry about all the unnecessary information, the use of user defined colors makes this function more privacy minded, since only the user will be able to know which color is associated to which application.

If the user wants to check the priority notifications or access certain key functionality from applications that are active in the background the Canvas state can be progressed to the Peek state.

Peek state (FIGS. 8E, 9E/FIG. 10, block 07c) is a state where the phone is in a half-lock status and allows for a quick peek at essential information and access to key functionalities. The LC Layer (FIGS. 8E and 9E/FIG. 10, block 06c) in this state is dimmed to 20% opacity, making the underlying information from the display (FIG. 10, block 07c) readable, but maintaining a certain barrier to long engagement from the user. Information in this state is presented in a summarized way, comprising a selection panel (FIG. 9E) (allowing the user to either view priority content or set up which content should have priority) and a series of cards (FIG. 9E) that using bigger type and color deliver glanceable and quick essential information. This information can be:

Cards representing key actionable data from task based applications such as control over music player, navigation instructions, notes, etc.

Cards with notifications from the priority apps, each card color coded in the same user defined color as the relative bubble in the canvas view

The Peek state is accessed performing a specific gesture, such as squeezing the sides of the phone within a specific force threshold that can be detected by HMI (FIG. 3, 304) elements such as force sensors embedded in the side of the device. Since some of the information that needs to be displayed in this half lock status could be personal and confidential to the user, during the LC Layer dimming process (FIG. 10, block 06c) the system will automatically try to recognize the user either by transitorily activating the front camera once the LC layer is transparent enough to allow recognition or by prompting other forms of authentication depending on the user preference. If authentication process (FIG. 10, block 05b) is successful (FIG. 10, block 05b, answer YES) the Peek GUI is displayed, otherwise (FIG. 10, block 05b, answer NO) both LC layer and display will revert to locked/canvas status. Full description of the process is available in the following section that explain FIG. 10 in detail.

FIG. 10 describes an expanded version of the system flowchart described by FIG. 7, the system is an expansion of the basic system, and therefore the initial part can be described in the same way as in FIG. 7.

At start of the operation (FIG. 10, block 01) the system listens for lock/unlock input (FIG. 10, block 02), that can be processed via the operation of a lock/unlock physical key on the device or analogue HMI interface such as pressure sensitive areas in the device display or side frame, when input is detected a timer for the time of the input being pressed is activated: based on a defined time threshold a long press of the lock/unlock key will activate a prompt to turn the device off, bringing the system to end status (FIG. 10, block 03), or short press, moving the system to the next status block that verifies the status of the display (FIG. 10, block 04) (locked or unlocked). If the display is not locked (FIG. 10, block 04, answer NO) the short press will move the system to locked status (FIG. 4A/5A) by setting the LC layer opacity to 100% (FIG. 10, block 06b), displaying the screen lock GUI (FIG. 10, block 07b) and moving back to the unlock input listener status (FIG. 10, block 02). If the status of the system is instead locked during the verification of lock/unlock status (FIG. 10, block 04, answer YES) the system moves to the block where it verifies the user ID authentication (FIG. 10, block 05a): this authentication can use various methods according to user preferences set up in the settings panel, such as fingerprint authentication, face recognition, voice identity recognition, password/unlock code input or recognition of connected devices such as smartwatch being present. If the user Identity verification (FIG. 10, block 05a) is not successful (FIG. 10, block 05a, answer NO) the system reverts to locked status after setting opacity of the LC layer to 100% (FIG. 10, block 06b) and displaying screen lock GUI (FIG. 10, block 07b). Depending on the user defined identification method the user identity authentication can transitorily modify the opacity of the LC layer so that, for example, it matches a threshold of opacity that allows the front camera and other optical sensor to recognize the user face. If the user authentication (FIG. 10, block 05a) is successful (FIG. 10, block 05a, answer YES) the status of the system moves toward unlocked status (FIG. 4B/5B) a different block by setting the LC layer opacity to 0% (FIG. 10, block 06a) and displaying the unlocked GUI (FIG. 10, block 07a) on the display module.

Following this point more detailed and specific description can detail the flowchart described in FIG. 10.

From Locked state screen lock GUI (FIG. 10, block 07b) with LC layer opacity set to 100% (FIG. 10, block 06b) the user can access important information and key functionalities by using specific gestures activated by squeezing the sides of the device, each status will adapt the display GUI and the LC layer opacity depending on the type of information that needs to be accessed or operation that needs to be performed.

A force sensor input (FIG. 10, block 08) is constantly recorded, if the input is absent or does not match any of the trigger thresholds (FIG. 10, block 08, answer NO), the system stays or reverts to LC film opacity 100% (FIG. 10, block 06b) and screen lock GUI (FIG. 10, block 07b). If the sensor input matches the threshold for activating the peek function (FIG. 10, block 09) (defined for example as a single light squeeze at less than 50% total possible force reading, for a duration inferior to 1 second) the system will proceed to the next step in the flowchart (FIG. 10, block 09, answer YES) by setting the LC layer opacity to 20% (FIG. 10, block 06c) and performing an attempt to authenticate the user (FIG. 10, block 05b) during the time this dimming is performed, by default by activating the camera to perform face recognition. If the authentication is not successful (FIG. 10, block 05b, answer NO) both LC layer and display will revert to locked/canvas status. If the authentication is successful (FIG. 10, block 05b, answer YES) the LC layer remains at the current set opacity of 20% (FIG. 10, block 06c) and the display layer showcase the Peek GUI (FIG. 10, block 07c) during this stage the user can check essential information such as priority notifications and active tasks, or set priorities.

Any further selection (FIG. 10, block 10) within a set time beyond these will result in moving the system (FIG. 10, block 10, answer YES) to a full unlock by changing opacity of LC layer to 0% (FIG. 10, block 06a) and displaying function relative unlocked GUI (FIG. 10, block 07a) (for example, clicking a mail notification card will result in full unlock and mail app being opened). If no further selection is performed within the timer (FIG. 10, block 10, answer NO) the system will revert to locked status with LC layer at 100% opacity (FIG. 10, block 06b) and screen lock GUI (FIG. 10, block 07b).

If during locked state the force sensor input (FIG. 10, block 08) does not recognize either zero input or the threshold force input for Peek (FIG. 10, block 09, answer NO) It will try to recognize the force threshold for camera shortcut (defined for example as a double light squeeze at less than 50% total possible force reading, for a duration inferior to 1.5 seconds). If this threshold is recognized (FIG. 10, block 11, Answer YES) the LC Layer opacity will be set to 0% (FIG. 10, block 06d) and the system will perform automatically user authentication (FIG. 10, block 12) during the time this dimming is performed, by default by activating the front camera to perform face recognition. If the authentication process fails (FIG. 10, block 12, answer NO) the LC Layer will remain in the current 0% opacity state and a limited camera GUI (FIG. 10, block 07e)will be activated allowing the guest user only to take photos or record video, until the lock/unlock input (FIG. 10, block 02) is registered to lock the display again. If the authentication process is successful (FIG. 10, block 12, answer YES) a full camera GUI (FIG. 10, block 07f) will be displayed instead, effectively unlocking the device in the camera app with 0% opacity LC layer (FIG. 10, block 06a, 07a).

If during the locked state the force sensor (FIG. 10, block 08) does not recognize either zero input or the threshold force input for Peek (FIG. 10, block 09, answer NO), or the threshold for camera shortcut (FIG. 10, block 11, answer NO), it will attempt to recognize the voice input force threshold (FIG. 10, block 13). If this threshold is not recognized (FIG. 10, block 13, answer NO) the system remain in locked status with LC layer at 100% opacity (FIG. 10, block 06b) and display with screen lock GUI (FIG. 10, block 07b), if otherwise the force sensor (FIG. 10, block 08) recognizes the threshold for voice input (defined for example as a strong squeeze at more than 70% total possible force reading, for a duration superior to 1.5 seconds) it will proceed to start voice input mode by setting LC layer opacity at 80% (FIG. 10, block 06e) and display voice GUI (FIG. 10, block 07g). During this status the system will translate the speech into text (FIG. 10, block STT) and analyze the type of query performed (FIG. 10, block 14). If the query type is about general public information (FIG. 10, block 14, answer GENERAL) (FIG. 10, block example weather forecast, read news, play music from an artist) it will proceed to display results (FIG. 10, block 07e) within the app as a text/voice answer that may be accompanied by a specific animation (e.g. temporarily further reducing the opacity of the LC layer to make some information readable). If instead the type of query is recognized as private (FIG. 10, block 14, answer PRIVATE) (for example, read my emails, show my photos from Spain, send a message to Mom) the system will automatically perform voice authentication (FIG. 10, block 05c) to assure that the input voice matches the registered voice of the user, or request another form of authentication if a voice profile is not registered. If the voice authentication is not successful (FIG. 10, block 05c, answer NO) the system reverts to locked status setting the LC layer to 100% opacity (FIG. 10, block 06b) and displaying locked GUI (FIG. 10, block 07b), if otherwise the authentication is successful (FIG. 10, block 05c, answer YES) the system will display the relative results. Any further selection (FIG. 10, block 10) beyond these within a set timer will result in moving the system (FIG. 10, block 10, Answer YES) to a full unlock by changing opacity of LC layer to 0% (FIG. 10, block 06a) and displaying function relative unlocked GUI (FIG. 10, block 07a) (for example, clicking a mail message result will result in full unlock and mail app being opened).

Laminating a switchable light diffusing layer above a smartphone display and linking the control systems to allow synchronized control according to different conditions and scenarios.

This system allows to produce smartphone devices that are uniquely differentiated in terms of aesthetics, due to having a display in locked status that does not appear simply black, but the color of the LC layer, with additional dynamic aesthetic properties achievable via interplay with the display layer.

This system also allows the user to manage their use of smartphone by providing a method to physically filter notifications and reduce digital noise, with the creation of new statuses for half-unlock and intermediate access to smartphone information.

This system also allows increasing user advantages correspond to increased product sales and unique selling points compared to our competition.

Other embodiments of the present disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes may be made without departing from the scope thereof. It is intended that the scope of the present disclosure only be limited by the appended claims.

1. A display assembly for a terminal device, comprising:
a display layer, capable of displaying information and being turned on and off; and
a switchable film, disposed above the display layer, and capable of changing opacity of the switchable film.

2. The display assembly of claim 1, further comprising: a first controller and a second controller, wherein
the first controller is configured to control the opacity of the switchable film according to inputs to the terminal device and the second controller is configured to control the display layer to be turned on and off and display information according to the inputs to the terminal device, so as to make the terminal device to be in a particular status.

3. The display assembly of claim 2, further comprising:
at least one sensor and/or at least one Human-Machine Interface (HMI); and
at least one processor, wherein
the at least one sensor is configured to sense change in condition of the terminal device and send a sensing result to at least one processor as inputs, and at least one HMI is configured to receive instructions and send the instructions to the at least one processor as inputs,
the at least one processor is configured to receive the inputs to the terminal device from the at least one sensor and/or at least one HMI and send the inputs to the first controller and second controller.

4. The display assembly of claim 2, wherein the first controller is configured to control the opacity of the switchable film to 100% and the second controller is configured to control the display layer to display a lockscreen Graphical User Interface (GUI) to make the terminal device to be in a locked status; or
wherein the first controller is configured to control the opacity of the switchable film to 0% and the second controller is configured to control the display layer to light up to make the terminal device to be in an unlocked status; or
wherein the first controller is configured to control the opacity of the switchable film to 60% to 90% and the second controller is configured to control the display layer to display an interface of at least one particular application, to make the terminal device to be in a half-locked status where the at least one particular application is capable of being accessed; or
wherein the first controller is configured to control the opacity of the switchable film to 100% and the second controller is configured to control the display layer to use Always On Display (AOD) functionality to display a graphical representation of notifications from at least one application having priority, to make the terminal device to be in a locked status; or
wherein the first controller is configured to control the opacity of the switchable film to 10% to 30%, and the second controller is configured to control the display layer to display information in a summarized way, to make the terminal device to be in a half-locked status.

5. The display assembly of claim 1, wherein the switchable film is made of at least one of liquid crystal or electrochromic glass.

6. The display assembly of claim 1, wherein the opacity of the switchable film is ranged from 0% to 100%.

7. A terminal device, comprising:
a display assembly,
wherein the display assembly comprises:
a display layer, capable of displaying information and being turned on and off; and
a switchable film, disposed above the display layer, and capable of changing opacity of the switchable film.

8. The terminal device of claim 7, wherein the display assembly further comprises a first controller and a second controller, wherein the first controller is configured to control the opacity of the switchable film according to inputs to the terminal device and the second controller is configured to control the display layer to be turned on and off and display information according to the inputs to the terminal device, so as to make the terminal device to be in a particular status.

9. The terminal device of claim 8, wherein the display assembly further comprises:
at least one sensor and/or at least one Human-Machine Interface (HMI); and
at least one processor, wherein
the at least one sensor is configured to sense change in condition of the terminal device and send a sensing result to at least one processor as inputs, and at least one HMI is configured to receive instructions and send the instructions to the at least one processor as inputs,
the at least one processor is configured to receive the inputs to the terminal device from the at least one sensor and/or at least one HMI and send the inputs to the first controller and second controller.

10. The terminal device of claim 8, wherein the first controller is configured to control the opacity of the switchable film to 100% and the second controller is configured to control the display layer to display a lockscreen Graphical User Interface (GUI) to make the terminal device to be in a locked status; or
wherein the first controller is configured to control the opacity of the switchable film to 0% and the second controller is configured to control the display layer to light up to make the terminal device to be in an unlocked status; or
wherein the first controller is configured to control the opacity of the switchable film to 60% to 90% and the second controller is configured to control the display layer to display an interface of at least one particular application, to make the terminal device to be in a half-locked status where the at least one particular application is capable of being accessed; or
wherein the first controller is configured to control the opacity of the switchable film to 100% and the second controller is configured to control the display layer to use Always On Display (AOD) functionality to display a graphical representation of notifications from at least one application having priority, to make the terminal device to be in a locked status; or
wherein the first controller is configured to control the opacity of the switchable film to 10% to 30%, and the second controller is configured to control the display layer to display information in a summarized way, to make the terminal device to be in a half-locked status.

11. The terminal device of claim 7, wherein the switchable film is made of at least one of liquid crystal or electrochromic glass.

12. The terminal device of claim 7, wherein the opacity of the switchable film is ranged from 0% to 100%.

13. A method for operating a display assembly of a terminal device, the display assembly comprising: a display layer capable of displaying information and being turned on and off; and a switchable film disposed above the display layer, and capable of changing opacity of the switchable film; a first controller for controlling the switchable film; and a second controller for controlling the display layer, the method comprising an operation of:
controlling by the first controller, the opacity of the switchable film according to inputs to the terminal device and controlling, by the second controller, the display layer to be turned on and off and display information according to inputs to the terminal device, so as to make the terminal device to be in a particular status.

14. The method of claim 13, wherein terminal device further comprises at least one processor, and further comprises at least one sensor and/or at least one Human-Machine Interface (HMI), the method comprising:
sensing, by the least one sensor, change in condition of the terminal device and sending a sensing result to at least one processor as inputs, and/or receiving, by at least one HMI, instructions from a user of the terminal device and sending the instructions to the at least one processor as inputs; and
receiving, by the at least one processor, the inputs to the terminal device from the at least one of the sensor or HMI, and sending the inputs to the first controller and second controller.

15. The method of claim 13, wherein the operation comprises: controlling, by the first controller, the opacity of the switchable film to 100% and controlling, by the second controller, the display layer to display a lockscreen Graphical User Interface (GUI) to make the terminal device to be in a locked status; or
wherein the operation comprises: controlling, by the first controller, the opacity of the switchable film to 0%, and controlling, by the second controller, the display layer to light up, to make the terminal device to be in an unlocked status; or
wherein the operation comprises: controlling, by the first controller, the opacity of the switchable film to 60% to 90% and controlling, by the second controller, the display layer to display an interface of at least one particular application, to make the terminal device to be in a half-locked status where the at least one particular application is capable of being accessed; or
wherein the operation comprises: controlling, by the first controller, the opacity of the switchable film to 100% and controlling, by the second controller, the display layer to use Always On Display (AOD) functionality to display a graphical representation of notifications from at least one application having priority, to make the terminal device to be in a locked status; or
wherein the operation comprises: controlling, by the first controller, the opacity of the switchable film to 10% to 30% and controlling, by the second controller, the display layer to display information in a summarized way, to make the terminal device to be in a half-locked status.

16. The method of claim 13, wherein the operation comprises:
when the display assembly is in an unlocked status, responsive to receiving an input for changing status of the display assembly, controlling, by the first controller, the opacity of the switchable film to 100% and controlling, by the second controller, the display layer to display a lockscreen Graphical User Interface (GUI) to make the terminal device to be in a locked status.

17. The method of claim 14, wherein the operation comprises:
when the display assembly is in a locked status, responsive to receiving an input for changing status of the display assembly, performing, by the at least one processor, user identification authentication; and
responsive to a positive result of the user identification authentication, controlling, by the first controller, the opacity of the switchable film to 0% and controlling, by the second controller, the display layer to light up, to make the terminal device to be in an unlocked status.

18. The method of claim 13, wherein the operation comprises:
responsive to receiving an input for activating at least one particular application, controlling, by the first controller, the opacity of the switchable film to 60% to 90% and controlling, by the second controller, the display layer to display an interface of the at least one particular application, to make the terminal device to be in a half-locked status where the at least one particular application is capable of being accessed.

19. The method of claim 13, wherein the operation comprises:
when the display assembly is in an unlocked status, responsive to receiving an input for changing status of the display assembly, controlling, by the first controller, the opacity of the switchable film to 100% and controlling, by the second controller, the display layer to use Always On Display (AOD) functionality to display a graphical representation of notifications from at least one application having priority, to make the terminal device to be in a locked status.

20. The method of claim 14, wherein the operation comprises:
responsive to receiving an input for changing status of the display assembly to a half-locked status, controlling, by the first controller, the opacity of the switchable film to 10% to 30%;
performing, by the at least one processor, user identification authentication; and
responsive to a positive result of the user identification authentication, controlling, by the second controller, the display layer to display information in a summarized way, to make the terminal device to be in a half-locked status.
